(19) United States
(12) Patent Application Publication
(10) Pub. No.: US 2025/0277518 A1
(43) Pub. Date: Sep. 4, 2025

(54) PISTON FOR DISC BRAKE DEVICE AND DISC BRAKE DEVICE

(71) Applicant: AKEBONO BRAKE INDUSTRY CO., LTD., Tokyo (JP)

(72) Inventor: Takuhiko SATO, Tokyo (JP)

(73) Assignee: AKEBONO BRAKE INDUSTRY CO., LTD., Tokyo (JP)

(21) Appl. No.: 19/064,996

(22) Filed: Feb. 27, 2025

(30) Foreign Application Priority Data
Mar. 1, 2024 (JP) 2024-031028

(51) Int. Cl. F16D 65/18; F16D 55/228; F16D 65/78; F16D 65/84; F16D 121/04; F16D 125/06

(52) U.S. Cl. CPC F16D 65/18; F16D 65/84; F16D 55/228; F16D 2065/785; F16D 2121/04; F16D 2125/06

(57) ABSTRACT

A piston for a disc brake device includes: a cylindrical wall portion; a bottom portion; and a plurality of columnar ribs. The cylindrical wall portion includes an outer diameter side cylindrical portion including a seal sliding contact portion on an outer peripheral surface, and an inner diameter side cylindrical portion that includes a pad contact portion at an end portion on the other side in an axial direction. The plurality of columnar ribs are disposed to be inclined with respect to a piston central axis, and each have an end portion on one side in a length direction connected to a side surface on the other side in the axial direction of the bottom portion, and an end portion on the other side in the length direction connected to an inner peripheral surface of the inner diameter side cylindrical portion.

### CROSS-REFERENCE TO RELATED APPLICATIONS

This application is based on and claims priority under 35 USC §119 from Japanese Patent Application No. 2024-031028 filed on Mar. 1, 2024, the contents of which are incorporated herein by reference.

### TECHNICAL FIELD

The present disclosure relates to a piston for a disc brake device and a disc brake device.

### BACKGROUND

Disc brake devices are widely used for braking automobiles and motorcycles. During braking performed by the disc brake device, a pair of pads disposed on both sides of a rotor rotating together with a wheel are pressed against both side surfaces of the rotor by a piston. Then, a kinetic energy of a vehicle is converted into a thermal energy by friction generated between the pads and the rotor, thereby braking the vehicle. Therefore, heat is accumulated in the rotor. The heat accumulated in the rotor is dissipated to the surroundings, and some of the heat is transferred through the pads to the piston, and then to a brake oil and a piston seal.

As such a disc brake device, a floating-type disc brake device, an opposed-piston-type disc brake device, and the like are known.

FIG. 10 illustrates an opposed-piston-type disc brake device 100 having a structure in the related art described in JP2011-179676A.

The disc brake device 100 includes a caliper 101 fixed to a vehicle body and a plurality of pistons 102.

The caliper 101 includes an inner body 104 and an outer body 105 on both sides of a rotor 103 rotating together with a wheel. The inner body 104 and the outer body 105 each include a cylinder 106.

The piston 102 is fitted to the cylinder 106. The piston 102 and the cylinder 106 are sealed by a piston seal 107.

The piston 102 has a bottomed cylindrical shape as a whole, and includes a cylindrical wall portion 108 having a substantially cylindrical shape and a bottom portion 109. The bottom portion 109 closes an end portion on one side, which is disposed on a deep side of the cylinder 106, of the cylindrical wall portion 108.

In the structure in the related art described in JP2011-179676A, in order to make it difficult for heat transferred from pads 110a and 110b to the pistons 102 to be transferred to the piston seals 107, a structure of the cylindrical wall portion 108 forming the piston 102 is devised.

Specifically, the cylindrical wall portion 108 includes an outer diameter side cylindrical portion 111 whose outer peripheral surface is in sliding contact with the piston seal 107, an inner diameter side cylindrical portion 112 that presses the pads 110a and 110b with a tip end portion thereof, and an annular gap 113 formed between an inner peripheral surface of the outer diameter side cylindrical portion 111 and an outer peripheral surface of the inner diameter side cylindrical portion 112.

During braking, the disc brake device 100 is supplied with the brake oil from a master cylinder to the cylinder 106. Accordingly, the piston 102 fitted to the cylinder 106 of the inner body 104 is pushed out, and the pad 110a on an inner side supported by the caliper 101 is pressed against a side surface of the rotor 103. Similarly, the piston 102 fitted to the cylinder 106 of the outer body 105 is pushed out, and the pad 110b on an outer side supported by the caliper 101 is pressed against a side surface of the rotor 103. As a result, the rotor 103 is more strongly sandwiched by a pair of pads 110a and 110b, and the vehicle is braked.

In the disc brake device 100 having the structure in the related art, since the cylindrical wall portion 108 forming the piston 102 is divided into the outer diameter side cylindrical portion 111 that is in sliding contact with the piston seal 107 and the inner diameter side cylindrical portion 112 that presses the respective pads 110a and 110b, the heat is difficult to be transferred from the pads 110a and 110b to the piston seal 107. Therefore, a temperature rise of the piston seal 107 can be prevented, and deterioration of the piston seal 107 can be prevented. Further, the heat of the pads 110a and 110b is difficult to be transferred to the brake oil, and a temperature rise of the brake oil can be prevented.

Patent Literature 1: JP2011-179676A

According to the disc brake device 100 having the structure in the related art described in JP2011-179676A, it is possible to prevent the temperature rise of the brake oil and to make it difficult for the heat to be transferred to the piston seal 107. However, since the cylindrical wall portion 108 forming the piston 102 has a hollow structure, the rigidity may be insufficient.

On the one hand, since the disc brake device is provided on a road surface side with respect to a spring forming a suspension device in the vehicle, the disc brake device has a so- called unsprung load. Therefore, the piston forming the disc brake device is also required to be reduced in weight for a purpose of improving fuel efficiency and driving performance of the vehicle.

An object of the present disclosure is to provide a piston for a disc brake device that can prevent the temperature rise of the brake oil, make it difficult for heat to be transferred to a piston seal, prevent an increase in weight, and secure the rigidity.

### SUMMARY

A piston for a disc brake device according to an aspect of the present disclosure includes: a cylindrical wall portion having a bottomed cylindrical shape as a whole and having a substantially cylindrical shape; a bottom portion configured to close an end portion on one side in an axial direction, which is configured to be disposed on a deep side of the cylinder, of the cylindrical wall portion; and a plurality of columnar ribs disposed on a radially inner side of the cylindrical wall portion.

The cylindrical wall portion includes an outer diameter side cylindrical portion including a seal sliding contact portion on an outer peripheral surface, an inner diameter side cylindrical portion that is disposed on a radially inner side of the outer diameter side cylindrical portion and that includes a pad contact portion at an end portion on the other side in the axial direction protruding in the axial direction with respect to an end portion on the other side in the axial direction of the outer diameter side cylindrical portion, and an annular gap formed between an inner peripheral surface of the outer diameter side cylindrical portion and an outer peripheral surface of the inner diameter side cylindrical portion.

The plurality of columnar ribs are disposed to be inclined with respect to a piston central axis, and each have an end portion on one side in a length direction connected to a side surface on the other side in the axial direction of the bottom portion, and an end portion on the other side in the length direction connected to an inner peripheral surface of the inner diameter side cylindrical portion.

In the piston for the disc brake device according an aspect of the present disclosure, each of the plurality of columnar ribs has the end portion on the other side in the length direction connected to an end portion on the other side in the axial direction of the inner peripheral surface of the inner diameter side cylindrical portion.

In the piston for the disc brake device according to an aspect of the present disclosure, the plurality of columnar ribs are disposed radially around the piston central axis.

In the piston for the disc brake device according to an aspect of the present disclosure, each of the plurality of columnar ribs has the end portion on the one side in the length direction connected to an intermediate portion in the radial direction of the side surface on the other side in the axial direction of the bottom portion.

In the piston for the disc brake device according to an aspect of the present disclosure, the plurality of columnar ribs are disposed at equal intervals in a circumferential direction.

In the piston for the disc brake device according to an aspect of the present disclosure, the outer diameter side cylindrical portion, the inner diameter side cylindrical portion, and the plurality of columnar ribs are integrally formed.

In the piston for the disc brake device according to an aspect of the present disclosure, the outer diameter side cylindrical portion and the inner diameter side cylindrical portion are formed separately, and the inner diameter side cylindrical portion and the plurality of columnar ribs are integrally formed.

In the piston for the disc brake device according to an aspect of the present disclosure, the inner diameter side cylindrical portion has a communication hole penetrating in the radial direction.

In the piston for the disc brake device according to an aspect of the present disclosure, the communication hole is formed in a portion, in which a phase in the circumferential direction coincides with that of the columnar rib, of the inner diameter side cylindrical portion.

In the piston for the disc brake device according to an aspect of the present disclosure, the communication hole is formed in a vicinity of a connection portion, to which the end portion on the other side in the length direction of the columnar rib is connected, of the inner diameter side cylindrical portion.

In the piston for the disc brake device according to an aspect of the present disclosure, the communication hole is formed in a portion adjacent to one side in the axial direction of the connection portion.

In the piston for the disc brake device according to an aspect of the present disclosure, at least a portion of the communication hole is located on the other side in the axial direction with respect to the end portion on the other side in the axial direction of the outer diameter side cylindrical portion.

In the piston for the disc brake device according to an aspect of the present disclosure, a central axis of the communication hole is inclined with respect to the piston central axis in a direction approaching the one side in the axial direction when extending toward the radially inner side.

In the piston for the disc brake device according to an aspect of the present disclosure, a heat shielding plate is provided on a radially inner side of the inner diameter side cylindrical portion, and the heat shielding plate covers the side surface on the other side in the axial direction of the bottom portion in a state of being in contact with the plurality of columnar ribs.

In the piston for the disc brake device according to an aspect of the present disclosure, the heat shielding plate is configured to be engaged with the plurality of columnar ribs.

In the piston for the disc brake device according to an aspect of the present disclosure, each of the plurality of columnar ribs has an engagement protrusion on a portion in the length direction thereof, the heat shielding plate has engagement holes, and the engagement protrusions are configured to be engaged with the respective engagement holes.

A disc brake device according to an aspect of the present disclosure includes: a caliper having a cylinder; and a piston fitted into the cylinder.

In the disk brake device according to an aspect of the present disclosure, the piston is the piston for the disc brake device according to an aspect of the present disclosure.

### BRIEF DESCRIPTION OF DRAWINGS

FIG. 1 is a cross-sectional view illustrating a disc brake device according to a first embodiment of the present disclosure.

FIG. 2 is a front view illustrating a piston according to the first embodiment.

FIG. 3 is a cross-sectional view taken along a line A-A in FIG. 2.

FIG. 4 is a perspective view illustrating the piston according to the first embodiment.

FIG. 5 is a front view illustrating a piston body according to the first embodiment.

FIG. 6 is a combination of a cross-sectional view taken along a line B-O-B in FIG. 5 and a cross-sectional view taken along a line C-O-C in FIG. 5.

FIG. 7 is a perspective view illustrating the piston body according to the first embodiment.

FIG. 8 is a perspective view illustrating the piston body according to the first embodiment in a circumferential direction position different from that in FIG. 7.

FIG. 9 is a cross-sectional view illustrating a piston body according to a second embodiment of the present disclosure.

FIG. 10 is a cross-sectional view illustrating a disc brake device having a structure in the related art.

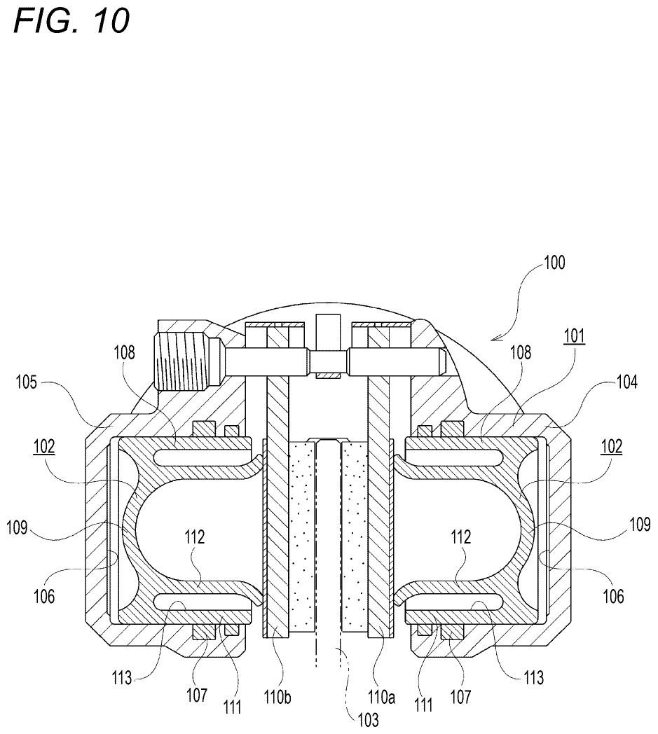

### DESCRIPTION OF EMBODIMENTS

### First Embodiment

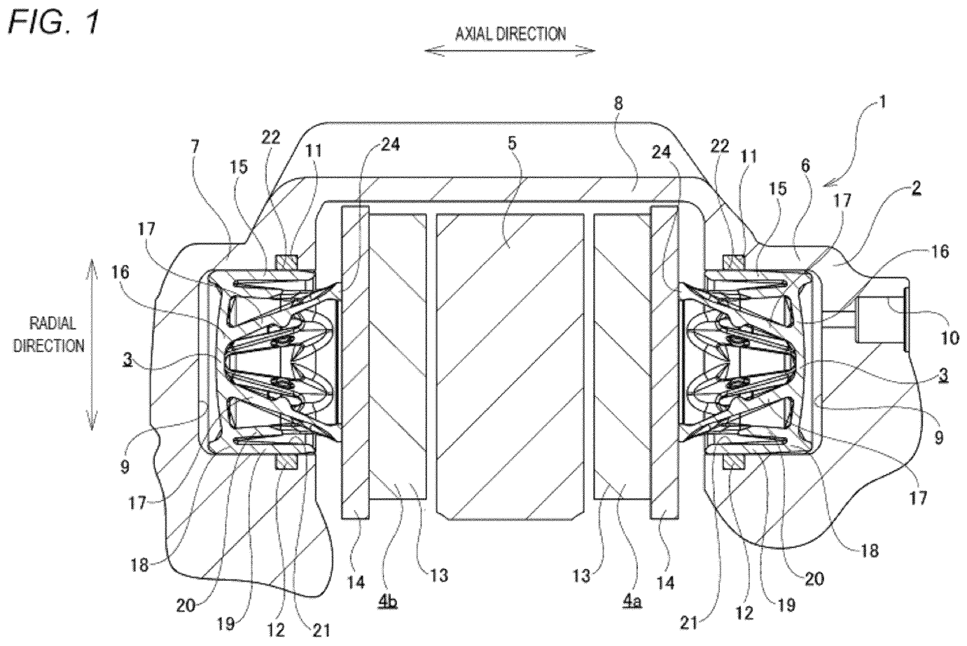

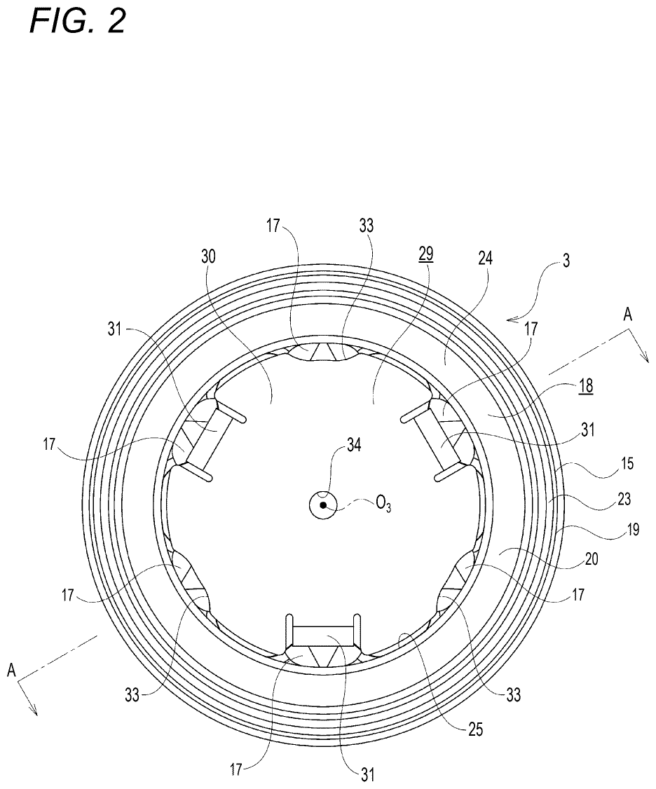

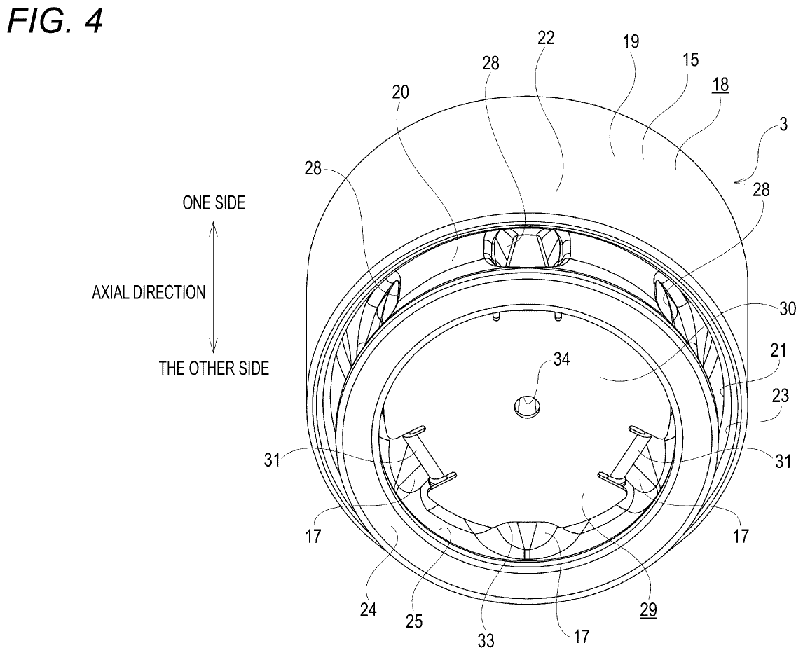

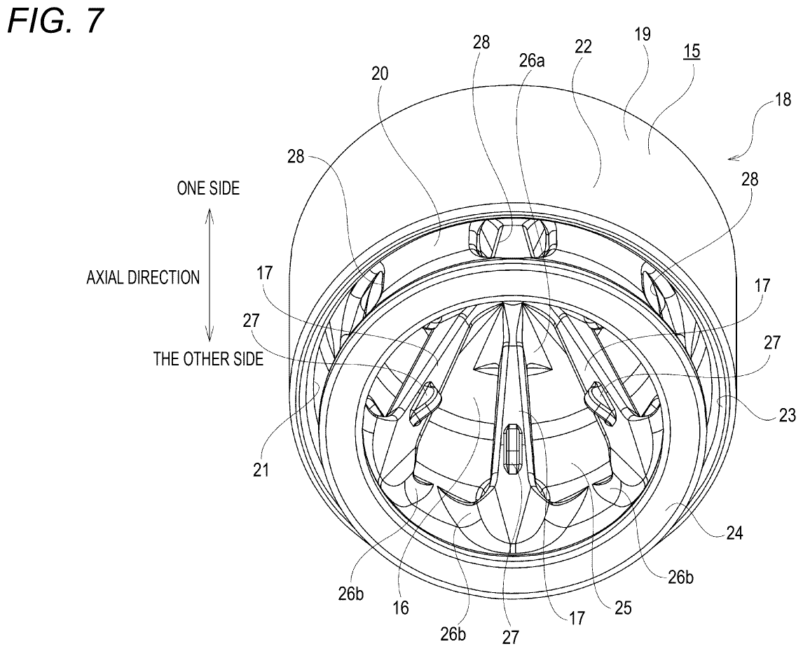

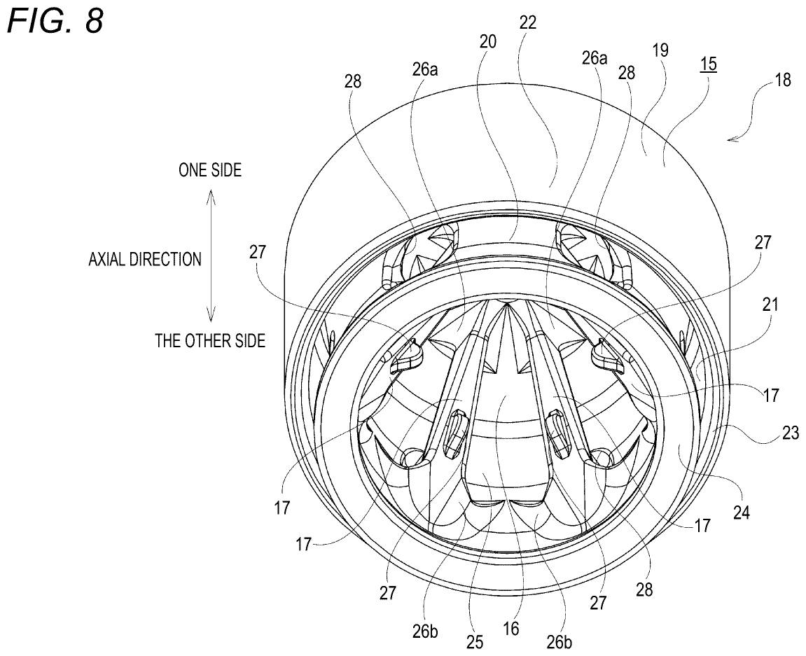

A first embodiment of the present disclosure will be described with reference to FIGS. 1 to 8.

In the present embodiment, a case is described in which a piston for a disc brake device according to an aspect of the present disclosure is applied to an opposed-piston-type disc brake device used for braking an automobile.

However, the piston for a disc brake device according to an aspect of the present disclosure may be applied not only to the opposed-piston-type disc brake device, but also to other disc brake devices such as a floating-type disc brake device.

Hereinafter, an overall structure of a disc brake device 1 will be described, and then a structure of a piston 3 in the present embodiment will be described in detail.

In the following description related to the disc brake device 1, unless otherwise specified, an axial direction, a circumferential direction, and a radial direction refer to an axial direction, a circumferential direction, and a radial direction of a disc-shaped rotor 5 (see FIG. 1) rotating together with a wheel. In FIG. 1, a left-right direction corresponds to the axial direction, a front-back direction corresponds to the circumferential direction, and an upper-lower direction corresponds to the radial direction. Further, a right side in FIG. 1, which is a center side of a vehicle body in an assembled state to the vehicle body, is referred to as an axially inner side, and a left side in FIG. 1, which is an outer side of the vehicle body in the assembled state to the vehicle body, is referred to as an axially outer side.

The disc brake device 1 in the present embodiment includes a caliper 2, a plurality of pistons 3, and a pair of pads 4a and 4b.

The caliper 2 is supported and fixed to a knuckle of a suspension device in a state in which the caliper 2 covers the rotor 5 from the radially outer side. The caliper 2 supports the pair of pads 4a and 4b to be movable in the axial direction.

The caliper 2 is integrally formed by subjecting a material made of a light alloy such as an aluminum alloy or an iron-based alloy to a casting process or the like.

The caliper 2 includes an inner body 6 and an outer body 7 disposed to sandwich the rotor 5, and a bridge 8 connecting the inner body 6 and the outer body 7 in the axial direction.

The inner body 6 is disposed on the center side of the vehicle body with respect to the rotor 5 in the axial direction. The outer body 7 is disposed on the outer side of the vehicle body with respect to the rotor 5 in the axial direction. The bridge 8 is disposed on the radially outer side of the rotor 5.

The inner body 6 and the outer body 7 each include a cylinder 9. The cylinder 9 has a substantially cylindrical space. The cylinder 9 provided in the inner body 6 is open to an axially outer surface of the inner body 6. The cylinder 9 provided in the outer body 7 is open to an axially inner surface of the outer body 7. The inner body 6 and the outer body 7 each have an oil passage (not illustrated) for supplying a brake oil from a master cylinder to the cylinder 9. The inner body 6 includes a connection portion 10 for connecting a brake hose between the inner body 6 and the master cylinder.

The inner body 6 and the outer body 7 each have, around a portion on an opening side of the cylinder 9, a seal groove 11 having an annular shape. A piston seal 12 made of an elastic material is attached to the seal groove 11.

The piston 3 is fitted to the cylinder 9. Specifically, the pistons 3 are fitted to the respective cylinders 9 provided in the inner body 6 and the outer body 7. The piston 3 and the cylinder 9 are sealed by the piston seal 12.

In the present embodiment, a case is illustrated in which the piston for a disc brake device according to an aspect of the present disclosure is fitted to each of a cylinder provided in an inner body and a cylinder provided in an outer body. However, the piston for an opposed-type disc brake device according to an aspect of the present disclosure may be fitted to only one cylinder of the cylinder provided in the inner body and the cylinder provided in the outer body.

The pair of pads 4a and 4b each include a lining 13 and a metal back plate 14 supporting a back surface of the lining 13. The back surface of the lining 13 refers to an axially inner surface for the lining 13 of the pad 4a on an inner side, and refers to an axially outer surface for the lining 13 of the pad 4b on an outer side. The pad 4a on the inner side of the pair of pads 4a and 4b, which is disposed on the axially inner side of the rotor 5, is supported by the inner body 6 to be movable in the axial direction. The pad 4b on the outer side of the pair of pads 4a and 4b, which is disposed on the axially outer side of the rotor 5, is supported by the outer body 7 to be movable in the axial direction.

During braking, the disc brake device 1 is supplied with the brake oil from the master cylinder to the cylinder 9. Accordingly, the piston 3 fitted to the cylinder 9 of the inner body 6 is pushed out, and the lining 13 of the pad 4a on the inner side is pressed against an axially inner surface of the rotor 5. Further, since the cylinder 9 of the inner body 6 and the cylinder 9 of the outer body 7 are connected by a tubing or the like (not illustrated) and form a hydraulic circuit, similarly, the piston 3 fitted to the cylinder 9 of the outer body 7 is pushed out, and the lining 13 of the pad 4b on the outer side is pressed against an axially outer surface of the rotor 5. As a result, the rotor 5 is strongly sandwiched by the linings 13 of the pair of pads 4a and 4b in the axial direction, and a vehicle is braked.

The structure of the piston 3 in the present embodiment will be described in detail below.

In the following description, unless otherwise specified, the axial direction, the circumferential direction, and the radial direction refer to an axial direction, a circumferential direction, and a radial direction of the piston 3. The axial direction of the piston 3 coincides with the axial direction of the rotor 5. In a state in which the piston 3 is fitted to the cylinder 9, a deep side of the cylinder 9 is referred to as one side in the axial direction, and an opening side of the cylinder 9 is referred to as the other side in the axial direction. That is, in the piston 3 fitted to the cylinder 9 of the inner body 6, the axially inner side corresponds to the one side in the axial direction, and the axially outer side corresponds to the other side in the axial direction. In contrast, in the piston 3 fitted to the cylinder 9 of the outer body 7, the axially outer side corresponds to the one side in the axial direction, and the axially inner side corresponds to the other side in the axial direction.

### [Structure of Piston]

The piston 3 has a piston central axis O₃ and has a bottomed cylindrical shape as a whole.

The piston 3 includes a cylindrical wall portion 15, a bottom portion 16, and a plurality of columnar ribs 17.

The piston 3 is manufactured by a selective laser sintering (SLS) method using a metal powder of a titanium alloy, an aluminum alloy, an iron alloy, or the like. However, the piston for a disc brake device according to an aspect of the present disclosure may be manufactured by using various three-dimensional object shaping methods {for example, a fused deposition modeling method, an inkjet method, a powder binding method, a stereolithography method, a laser engineered net shaping (LENS) method, a fused deposition modeling (FDM) method}.

In the piston 3 in the present embodiment, the cylindrical wall portion 15, the bottom portion 16, and the plurality of columnar ribs 17 are integrally formed. The cylindrical wall portion 15, the bottom portion 16, and the plurality of columnar ribs 17 form a piston body 18 which is one component.

In a non-braking state, an end portion on the other side in the axial direction of cylindrical wall portion 15 of the piston 3 is exposed from the cylinder 9.

The cylindrical wall portion 15 has a substantially cylindrical shape and is hollow. In the present embodiment, the cylindrical wall portion 15 has a substantially U-shaped cross section.

The cylindrical wall portion 15 includes an outer diameter side cylindrical portion 19, an inner diameter side cylindrical portion 20, and an annular gap 21.

In the present embodiment, since the cylindrical wall portion 15 and the plurality of columnar ribs 17 are integrally formed, the outer diameter side cylindrical portion 19, the inner diameter side cylindrical portion 20, and the plurality of columnar ribs 17 are integrally formed.

The outer diameter side cylindrical portion 19 forms a radially outer side portion of the cylindrical wall portion 15 and has a substantially cylindrical shape. An outer peripheral surface of the outer diameter side cylindrical portion 19 forms an outer peripheral surface of the cylindrical wall portion 15 and has a cylindrical surface shape. An outer diameter of the outer diameter side cylindrical portion 19 is slightly smaller than an inner diameter of the cylinder 9. A radial thickness of the outer diameter side cylindrical portion 19 is substantially constant in the axial direction.

The outer diameter side cylindrical portion 19 includes a seal sliding contact portion 22 on the outer peripheral surface. The seal sliding contact portion 22 is provided at an intermediate portion in the axial direction of the outer peripheral surface of the outer diameter side cylindrical portion 19. The seal sliding contact portion 22 is in sliding contact with the piston seal 12 in the axial direction.

The outer diameter side cylindrical portion 19 has, at an end portion on the other side in the axial direction of an inner peripheral surface, a tapered surface 23 whose inner diameter increases toward the other side in the axial direction.

The inner diameter side cylindrical portion 20 forms a radially inner side portion of the cylindrical wall portion 15 and has a substantially cylindrical shape. The inner diameter side cylindrical portion 20 is located on a radially inner side of the outer diameter side cylindrical portion 19 and is disposed such that most of the inner diameter side cylinder portion 20 overlaps with the outer diameter side cylindrical portion 19 in the radial direction. The inner diameter side cylindrical portion 20 is disposed coaxially with the outer diameter side cylindrical portion 19. The inner diameter side cylindrical portion 20 and the outer diameter side cylindrical portion 19 are separated from each other in the radial direction, and are connected only at end portions on the one side in the axial direction.

In the present embodiment, an outer peripheral surface of the inner diameter side cylindrical portion 20 is a concave curved surface having a concave arc-shaped cross section, in which an outer diameter smoothly decreases toward an intermediate portion in the axial direction. Most of an inner peripheral surface of the inner diameter side cylindrical portion 20 is a convex curved surface having a convex arc-shaped cross section, in which an inner diameter smoothly decreases toward the intermediate portion in the axial direction. However, when the piston for a disc brake device according to an aspect of the present disclosure is implemented, the outer peripheral surface and the inner peripheral surface of the inner diameter side cylindrical portion may have the cylindrical surface shape.

In the present embodiment, the end portion on the one side in the axial direction of the inner diameter side cylindrical portion 20 is offset towards the other side in the axial direction with respect to the end portion on the one side in the axial direction of the outer diameter side cylindrical portion 19. In other words, the end portion on the one side in the axial direction of the outer diameter side cylindrical portion 19 protrudes in the axial direction with respect to the end portion on the one side in the axial direction of the inner diameter side cylindrical portion 20. Specifically, the end portion on the one side in the axial direction of the inner diameter side cylindrical portion 20 is connected to a portion, which is closer to one side in the axial direction, of the inner peripheral surface of the outer diameter side cylindrical portion 19.

A portion on the other side in the axial direction of the inner diameter side cylindrical portion 20 protrudes in the axial direction with respect to the end portion on the other side in the axial direction of the outer diameter side cylindrical portion 19. The inner diameter side cylindrical portion 20 includes a pad contact portion 24 at an end portion on the other side in the axial direction. In the present embodiment, in the non-braking state, a portion including the pad contact portion 24, which protrudes in the axial direction with respect to the end portion on the other side in the axial direction of the outer diameter side cylindrical portion 19, of the inner diameter side cylindrical portion 20 is exposed from the cylinder 9.

In the present embodiment, since the pad contact portion 24 protrudes in the axial direction from the outer diameter side cylindrical portion 19, the outer diameter side cylindrical portion 19 does not directly contact the pads 4a and 4b. Therefore, it is possible to effectively prevent heat of the pads 4a and 4b from being directly transferred to the outer diameter side cylindrical portion 19 and reaching the brake oil. A portion, to which the heat is directly transferred due to contact with the pads 4a and 4b, of the piston 3 is a pad contact portion 24. Therefore, in order to transfer the heat from the pad contact portion 24 to the piston seal 12, the heat needs to be transferred through the inner diameter side cylindrical portion 20 and the columnar ribs 17 to the outer diameter side cylindrical portion 19 via the bottom portion 16, and a heat transfer distance is sufficiently long. Therefore, the heat transferred to the piston seal 12 is sufficiently prevented.

The pad contact portions 24 are in contact with the respective back plates 14 of the pads 4a and 4b. A radial thickness of the pad contact portion 24 is larger than a radial thickness of a portion, which is separated from the pad contact portion 24, of the inner diameter side cylindrical portion 20. The radial thickness of the portion, which is separated from the pad contact portion 24, of the inner diameter side cylindrical portion 20 is substantially the same as the radial thickness of the outer diameter side cylindrical portion 19.

An end surface on the other side in the axial direction of the pad contact portion 24 has a circular ring shape and is a flat surface on a virtual plane orthogonal to the piston central axis O₃.

The annular gap 21 is an annular gap portion formed between the inner peripheral surface of the outer diameter side cylindrical portion 19 and the outer peripheral surface of the inner diameter side cylindrical portion 20, and forms a so-called heat insulation and heat dissipation portion. That is, a heat insulation effect can be expected by an air layer present in the annular gap 21, and heat dissipation is performed by movement of the air layer. The annular gap 21 is open to the other side in the axial direction. An end portion on the one side in the axial direction of the annular gap 21 (a bottom portion in the axial direction) is located on the one side in the axial direction with respect to the seal sliding contact portion 22.

A radial thickness of the annular gap 21 is substantially constant in the axial direction, but a radial thickness of a portion in which the tapered surface 23 is provided on the inner peripheral surface of the outer diameter side cylindrical portion 19 is larger than a radial thickness of the other portion.

The bottom portion 16 closes an end portion on the one side in the axial direction, which is disposed on the deep side of the cylinder 9, of the cylindrical wall portion 15. The bottom portion 16 has a substantially disc-shape. An outer peripheral edge portion of the bottom portion 16 is connected to the end portion on the other side in the axial direction of the inner diameter side cylindrical portion 20 forming the cylindrical wall portion 15.

A side surface on the one side in the axial direction of the bottom portion 16 is a partially spherical convex surface slightly bulging to the one side in the axial direction. A side surface on the other side in the axial direction of the bottom portion 16 is a partially spherical concave surface slightly recessed toward the one side in the axial direction. However, when the piston for a disc brake device according to an aspect of the present disclosure is implemented, a bottom portion may have a flat plate shape.

An axial thickness of the bottom portion 16 is substantially constant in the radial direction and the circumferential direction. In the present embodiment, the axial thickness of the bottom portion 16 is substantially the same as the radial thickness of the portion, which is separated from the pad contact portion 24, of the inner diameter side cylindrical portion 20 and the radial thickness of the outer diameter side cylindrical portion 19.

The plurality of columnar ribs 17 have a function of ensuring the rigidity of the piston 3. Specifically, the plurality of columnar ribs 17 improve the rigidity of the inner diameter side cylindrical portion 20, which presses the respective pads 4a and 4b during braking, of the cylindrical wall portion 15 forming the piston 3.

Although the number of the columnar ribs 17 is not limited thereto, the piston 3 may include, for example, 3 to 12 columnar ribs 17. In the present embodiment, the piston 3 includes six columnar ribs 17.

The plurality of columnar ribs 17 are disposed on a radially inner side of the cylindrical wall portion 15. Specifically, the plurality of columnar ribs 17 are disposed in a piston internal space 25 that is present on a radially inner side of the inner diameter side cylindrical portion 20 forming the cylindrical wall portion 15.

The columnar rib 17 has a straight elongated shape. In the present embodiment, the columnar rib 17 has a substantially trapezoidal cross section and has a quadrangular prism shape whose cross-sectional shape changes in a length direction. However, when the piston for a disc brake device according to an aspect of the present disclosure is implemented, the columnar rib is not particularly limited in a shape thereof, and may have any shape such as a triangular column shape, a rectangular column shape, a trapezoidal column shape, a polygonal column shape such as a pentagonal column or a hexagonal column, a columnar shape, an elliptical column shape, a truncated conical shape, or a polygonal pyramid shape.

The columnar rib 17 is solid as a whole. However, a columnar rib may be hollow.

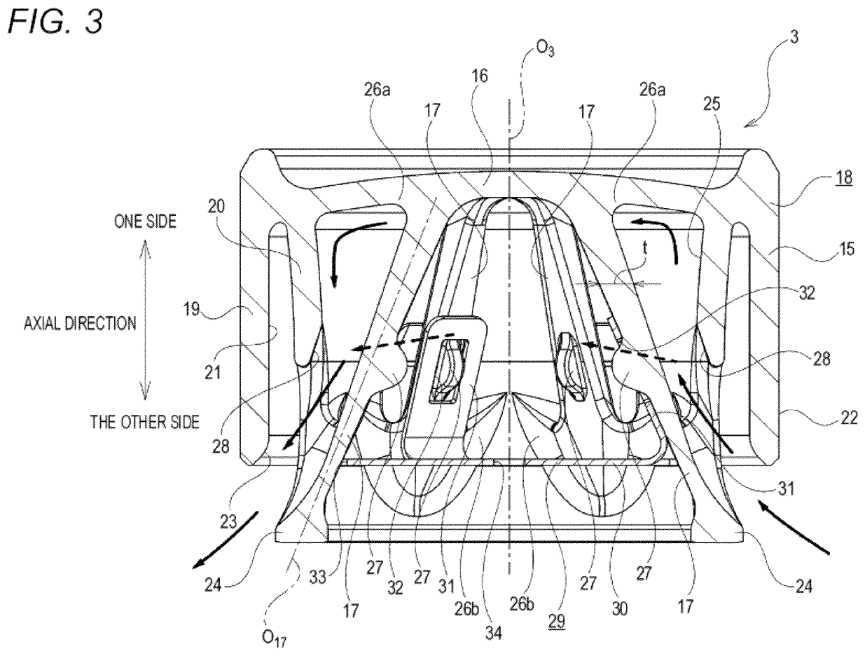

The plurality of columnar ribs 17 are disposed to be inclined with respect to the piston central axis O₃. That is, a central axis O₁₇ (see FIG. 3) of the columnar rib 17 is inclined with respect to the piston central axis O₃.

The plurality of columnar ribs 17 each have an end portion on one side in the length direction connected to the side surface on the other side in the axial direction of the bottom portion 16, and an end portion on the other side in the length direction connected to the inner peripheral surface of the inner diameter side cylindrical portion 20. Therefore, the central axis O₁₇ of the columnar rib 17 is inclined with respect to the piston central axis O₃ in a direction approaching the radially outer side from the one side in the length direction toward the other side in the length direction.

In the present embodiment, the plurality of columnar ribs 17 each have the end portion on the one side in the length direction connected to an intermediate portion in the radial direction of the side surface on the other side in the axial direction of the bottom portion 16, and the end portion on the other side in the length direction connected to an end portion on the other side in the axial direction of the inner peripheral surface of the inner diameter side cylindrical portion 20. That is, the end portion on the other side in the length direction of the columnar rib 17 is connected to the pad contact portion 24.

The columnar rib 17 is not connected to the bottom portion 16 and the inner diameter side cylindrical portion 20 at a portion other than the end portions on both sides in the length direction.

In the present embodiment, the plurality of columnar ribs 17 are disposed at equal intervals in the circumferential direction, and are disposed radially around the piston central axis O₃. The plurality of columnar ribs 17 are separated from each other in the circumferential direction, and are independent of each other. In other words, two columnar ribs 17 adjacent to each other in the circumferential direction are not connected to each other. However, two columnar ribs adjacent to each other in the circumferential direction may be connected to each other in the circumferential direction.

In the present embodiment, a thickness t (see FIG. 3) of the columnar rib 17 in the radial direction decreases from the one side in the length direction toward the other side in the length direction.

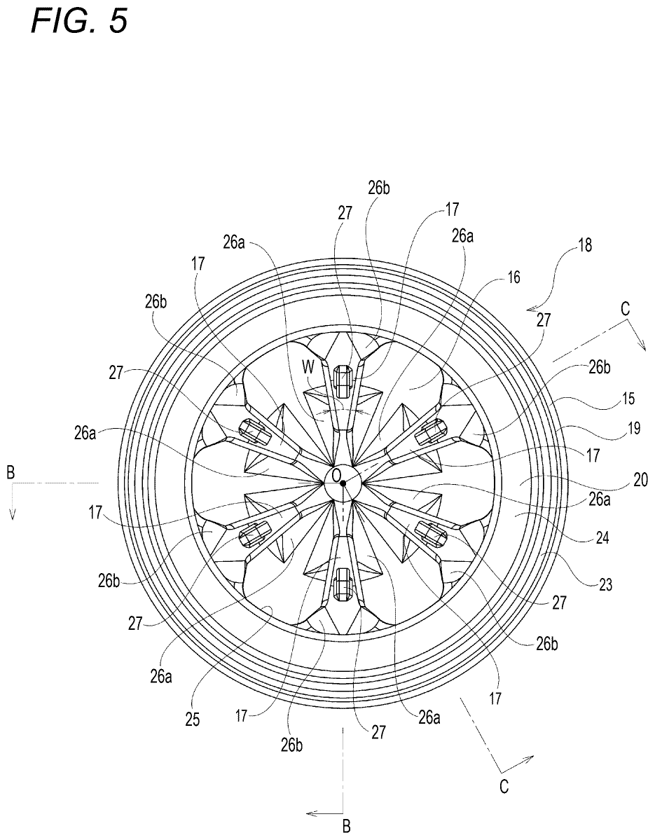

A width w (see FIG. 5) of the columnar rib 17 in the circumferential direction increases from the one side in the length direction toward the other side in the length direction, except for the end portions on both sides in the length direction of the columnar rib 17.

A first reinforcing portion 26a protruding in the radial direction and the circumferential direction is provided at the end portion on the one side in the length direction of the columnar rib 17. A second reinforcing portion 26b protruding in the circumferential direction is provided at the end portion on the other side in the length direction of the columnar rib 17.

In the present embodiment, an engagement protrusion 27 for attaching a heat shielding plate 29 described later is formed on a portion of the columnar rib 17 in the length direction. The engagement protrusion 27 is formed on a radially inner surface of an intermediate portion in the length direction of the columnar rib 17, and protrudes toward the radially inner side. In the present embodiment, the engagement protrusion 27 is formed on all the columnar ribs 17, respectively, but it is not necessary that the engagement protrusion 27 is formed on all the columnar ribs 17, respectively.

The engagement protrusion 27 has a substantially triangular plate shape. However, the engagement protrusion is not limited to a triangular plate shape, and may have other shape such as a hemispherical shape.

In the piston 3 in the present embodiment, the inner diameter side cylindrical portion 20 has communication holes 28 penetrating in the radial direction. The communication hole 28 allows the annular gap 21 to communicate with the piston internal space 25. However, when the piston for a disc brake device according to an aspect of the present disclosure is implemented, it is optional to form a communication hole in the inner diameter side cylindrical portion.

The inner diameter side cylindrical portion 20 has a plurality of communication holes 28. In the present embodiment, the inner diameter side cylindrical portion 20 has the same number of the communication holes 28 as the columnar ribs 17. However, the number of the communication holes formed in the inner diameter side cylindrical portion may not be the same as the number of the columnar ribs.

In the present embodiment, each of the plurality of communication holes 28 is formed in a portion, in which a phase in the circumferential direction coincides with that of the respective columnar rib 17, of the inner diameter side cylindrical portion 20. Therefore, the plurality of communication holes 28 are formed at equal intervals in the circumferential direction.

The communication hole 28 is formed in a vicinity of a connection portion, to which the end portion on the other side in the length direction of the columnar rib 17 is connected, of the inner diameter side cylindrical portion 20. In the present embodiment, the communication hole 28 is formed in a portion, which is adjacent to one side in the axial direction of the connection portion to which the end portion on the other side in the length direction of the columnar rib 17 is connected, of the inner diameter side cylindrical portion 20. Here, since the end portion on the other side in the length direction of the columnar rib 17 is connected to the end portion on the other side in the axial direction of the inner peripheral surface of the inner diameter side cylindrical portion 20, the communication hole 28 is formed in a portion that is closer to the other side in the axial direction of the inner diameter side cylindrical portion 20.

At least a portion of the communication hole 28 is located on the other side in the axial direction with respect to the end portion on the other side in the axial direction of the outer diameter side cylindrical portion 19. In the present embodiment, a half portion of the communication hole 28 on the other side in the axial direction is located on the other side in the axial direction with respect to the end portion on the other side in the axial direction of the outer diameter side cylindrical portion 19. That is, the half portion of the communication hole 28 on the other side in the axial direction is a portion exposed from the outer diameter side cylindrical portion 19. Therefore, in the non-braking state, the half portion of the communication hole 28 on the other side in the axial direction is exposed from the cylinder 9. The half portion of the communication hole 28 on the one side in the axial direction is a portion covered by the outer diameter side cylindrical portion 19. Specifically, the half portion of the communication hole 28 on the one side in the axial direction is covered by the outer diameter side cylindrical portion 19 from the radially outer side.

In the present embodiment, the communication hole 28 has a substantially rectangular opening shape as viewed in the radial direction. However, the opening shape of the communication hole is not limited to a rectangular shape, and may have any shape such as a circle, an ellipse, a triangle, or a polygon.

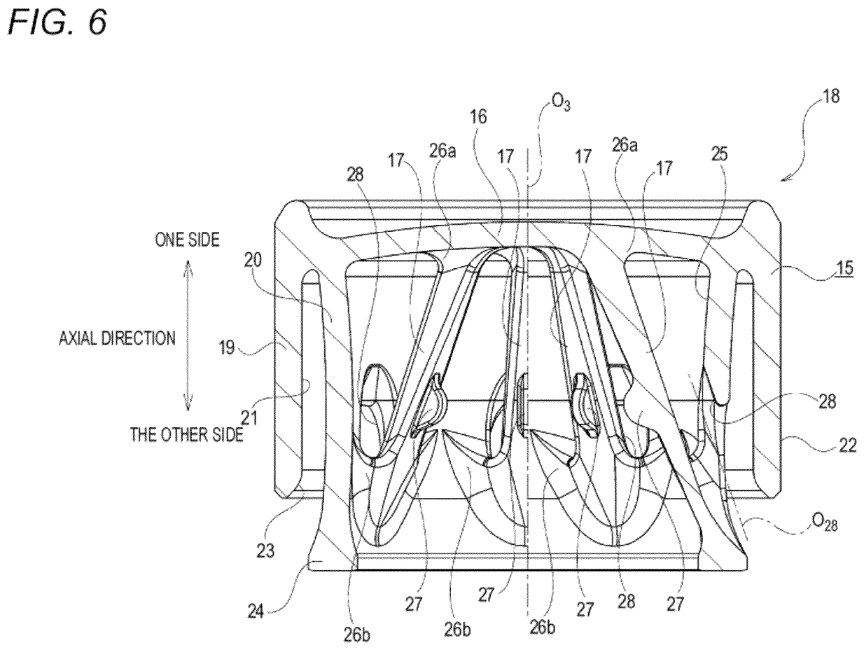

A central axis O₂₈ (see FIG. 6) of the communication hole 28 is inclined with respect to the piston central axis O₃ in a direction approaching the one side in the axial direction when extending toward the radially inner side. Therefore, an extension line of the central axis O₂₈ of the communication hole 28 passes through the side surface on the other side in the axial direction of the bottom portion 16.

The piston 3 in the present embodiment further includes a heat shielding plate 29 in addition to the piston body 18. The heat shielding plate 29 has a function of preventing the heat from being transferred from the pads 4a and 4b to the bottom portion 16. However, when the piston for a disc brake device according to an aspect of the present disclosure is implemented, it is optional to provide a heat shielding plate.

The heat shielding plate 29 is provided separately from the cylindrical wall portion 15, the bottom portion 16, and the columnar ribs 17. That is, the heat shielding plate 29 is provided separately from the piston body 18.

The heat shielding plate 29 is made of a metal plate. In the present embodiment, the heat shielding plate 29 is manufactured by pressing a stainless steel plate.

The heat shielding plate 29 is disposed on the radially inner side of the inner diameter side cylindrical portion 20 forming the cylindrical wall portion 15. That is, the heat shielding plate 29 is disposed in the piston internal space 25.

The heat shielding plate 29 covers the side surface on the other side in the axial direction of the bottom portion 16 in a state of being in contact with the plurality of columnar ribs 17. In the present embodiment, the heat shielding plate 29 is in contact with the plurality of columnar ribs 17 by engaging with the plurality of columnar ribs 17.

The heat shielding plate 29 includes a lid portion 30 having a substantially disc-shape and a plurality of engagement pieces 31.

In the present embodiment, the number of the engagement pieces 31 of the heat shielding plate 29 is half that of the columnar ribs 17. However, the number of engagement pieces provided on the heat shielding plate is not limited to half that of the columnar ribs. The plurality of engagement pieces 31 are disposed at equal intervals in the circumferential direction.

The engagement piece 31 has a substantially rectangular plate shape, and a base end portion of the engagement piece 31 is connected to an outer peripheral edge portion of the lid portion 30. The engagement piece 31 is bent in a direction approaching the piston central axis O₃ from a base end side toward a tip end side.

The engagement piece 31 has an engagement hole 32 having a hole shape, which can be engaged with the engagement protrusion 27. In the present embodiment, the engagement hole 32 is a rectangular hole.

The heat shielding plate 29 cannot fall off into the piston internal space 25 by engaging the engagement protrusions 27 with the respective engagement holes 32 formed in the plurality of engagement pieces 31.

In the present embodiment, the lid portion 30 has a notch 33, into which a portion on the other side in the axial direction of the columnar rib 17 can be inserted, between two engagement pieces 31 adjacent to each other in the circumferential direction in the outer peripheral edge portion. The lid portion 30 has, at the center thereof, a small hole 34 into which a tip end portion of a tool can be engaged when the heat shielding plate 29 is removed.

According to the piston 3 in the present embodiment, it is possible to prevent a temperature rise of the brake oil, to make it difficult for the heat to be transferred to the piston seal 12, to prevent an increase in weight, and to secure the rigidity.

That is, the cylindrical wall portion 15 forming the piston 3 in the present embodiment is divided into the outer diameter side cylindrical portion 19 including the seal sliding contact portion 22 on the outer peripheral surface, and the inner diameter side cylindrical portion 20 including the pad contact portion 24 at the end portion on the other side in the axial direction. Therefore, the heat of the pads 4a and 4b is difficult to be transferred to the seal sliding contact portion 22. That is, in the piston 3 in the present embodiment, since a heat transfer distance from the pad contact portion 24 to the seal sliding contact portion 22 is longer than that in a case in which a seal sliding contact portion and a pad contact portion are provided in a same cylindrical portion, the heat of the pads 4a and 4b is difficult to be transferred to the seal sliding contact portion 22. In particular, in the present embodiment, since the inner diameter side cylindrical portion 20 and the outer diameter side cylindrical portion 19 are connected only at the end portions on the one side in the axial direction, the heat transfer distance is sufficiently long, and the heat of the pads 4a and 4b is difficult to be transferred to the seal sliding contact portion 22. Therefore, it is possible to make it difficult for the heat to be transferred to the piston seal 12. As a result, a temperature rise of the piston seal 12 is prevented, and the deterioration of the piston seal 12 is prevented.

Since the piston 3 in the present embodiment includes the plurality of columnar ribs 17 in order to ensure the rigidity, it is possible to prevent the increase in weight and to secure the rigidity of the piston 3. In particular, the plurality of columnar ribs 17 are each disposed to be inclined with respect to the piston central axis O₃, and have the end portion on the one side in the length direction connected to the side surface on the other side in the axial direction of the bottom portion 16, and the end portion on the other side in the length direction connected to the inner peripheral surface of the inner diameter side cylindrical portion 20. Therefore, since the plurality of columnar ribs 17 are stretched between the inner diameter side cylindrical portion 20 that includes the pad contact portion 24 pressing the respective pads 4a and 4b during braking and the bottom portion 16, it is possible to sufficiently secure the rigidity of the inner diameter side cylindrical portion 20 in which the rigidity is particularly required.

Since a part of the heat transferred from the pads 4a and 4b to the pad contact portion 24 is also transferred to the columnar ribs 17, an amount of the heat transferred to the bottom portion 16 is less than that in a case in which no columnar rib 17 is provided. Therefore, the temperature rise of the brake oil between the bottom portion 16 and the cylinder 9 can be prevented.

In the piston 3 in the present embodiment, in the non-braking state, the portion, which protrudes in the axial direction with respect to the end portion on the other side in the axial direction of the outer diameter side cylindrical portion 19, of the inner diameter side cylindrical portion 20 is exposed from the cylinder 9. Further, the outer peripheral surface of the inner diameter side cylindrical portion 20 is the concave curved surface in which the outer diameter smoothly decreases toward the intermediate portion in the axial direction. Therefore, traveling wind during traveling of the vehicle hits a portion, which is exposed from the cylinder 9, of the outer peripheral surface of the inner diameter side cylindrical portion 20, and is guided to the one side in the axial direction (deep side) of the annular gap 21 along the outer peripheral surface of the inner diameter side cylindrical portion 20. Accordingly, since the outer diameter side cylindrical portion 19 is cooled, the temperature rise of the piston seal 12 is prevented.

Further, since the outer diameter side cylindrical portion 19 has the tapered surface 23 at the end portion on the other side in the axial direction of the inner peripheral surface, the traveling wind easily enters the annular gap 21. Therefore, from this point of view as well, the temperature rise of the piston seal 12 is prevented.

The piston 3 in the present embodiment has the communication holes 28 in the inner diameter side cylindrical portion 20. Therefore, the traveling wind is guided to the piston internal space 25 through the communication holes 28. Therefore, the bottom portion 16 can be cooled by using the traveling wind. Therefore, from this point of view as well, the temperature rise of the brake oil can be prevented.

In the present embodiment, since the communication hole 28 is formed in the portion, in which the phase in the circumferential direction coincides with that of the respective columnar rib 17, of the inner diameter side cylindrical portion 20, the traveling wind passing through the communication holes 28 hits the radially outer surfaces of the columnar ribs 17. Therefore, the columnar ribs 17 are cooled, and the traveling wind is guided to the bottom portion 16 along the columnar ribs 17. Therefore, the bottom portion 16 is effectively cooled.

At least a portion of the communication hole 28 is located on the other side in the axial direction with respect to the end portion on the other side in the axial direction of the outer diameter side cylindrical portion 19 and is exposed from the cylinder 9 in the non-braking state. Therefore, an amount of the wind guided to the bottom portion 16 through the communication holes 28 increases. Further, since the communication holes 28 are formed in the inner diameter side cylindrical portion 20, as indicated by arrows in FIG. 3, a cooling air introduced into the piston internal space 25 from the outside of the piston 3 through the communication holes 28 can be discharged to the outside of the piston 3 through the communication holes 28. That is, since the cooling air can be circulated by using the communication holes 28, heat stored in the piston 3 can be effectively dissipated. Further, as indicated by dashed arrows in FIG. 3, the cooling air introduced into the piston internal space 25 also passes between the columnar ribs 17.

Since the central axis O₂₈ of the communication hole 28 is inclined with respect to the piston central axis O₃ in the direction approaching the one side in the axial direction when extending toward the radially inner side, and the extension line of the central axis O₂₈ of the communication hole 28 passes through the side surface on the other side in the axial direction of the bottom portion 16, the traveling wind passing through the communication holes 28 is efficiently guided to the bottom portion 16.

Further, the communication hole 28 is formed in the vicinity of the connection portion, to which the end portion on the other side in the length direction of the columnar rib 17 is connected, of the inner diameter side cylindrical portion 20, that is, in a portion, which has a sufficiently high strength by being connected to the end portion on the other side in the length direction of the columnar rib 17, of the inner diameter side cylindrical portion 20. Therefore, a reduction in the strength of the inner diameter side cylindrical portion 20 caused by forming the communication holes 28 is efficiently prevented.

In the piston 3 in the present embodiment, since the heat shielding plate 29 is provided on the radially inner side of the inner diameter side cylindrical portion 20, the amount of the heat transferred from the pads 4a and 4b to the bottom portion 16 can be reduced.

In addition, since the heat shielding plate 29 cannot fall off into the piston internal space 25 by engaging the engagement protrusions 27 with the respective engagement holes 32 formed in the plurality of engagement pieces 31, it is possible to reduce a cost of the heat shielding plate 29 and to improve the workability of an attachment operation of the heat shielding plate 29.

### Second Embodiment

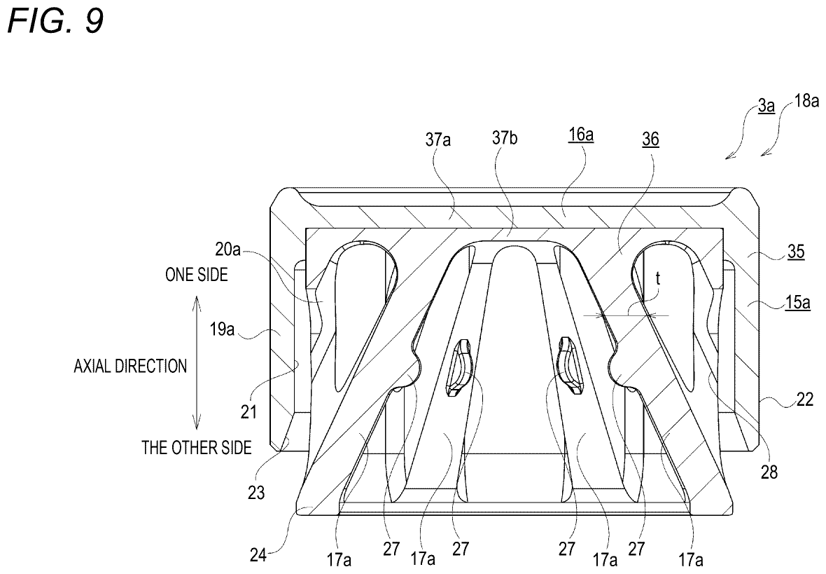

A second embodiment of the present disclosure will be described with reference to FIG. 9.

In the present embodiment, only a structure of a piston 3a is different from the structure of the piston 3 in the first embodiment.

In the piston 3a in the present embodiment, an outer diameter side cylindrical portion 19a and an inner diameter side cylindrical portion 20a, which form a cylindrical wall portion 15a, are formed separately, and the inner diameter side cylindrical portion 20a and a plurality of columnar ribs 17a are integrally formed.

In the present embodiment, a piston body 18a including the cylindrical wall portion 15a, the bottom portion 16a, and the plurality of columnar ribs 17a is not one component but includes two components. Specifically, the piston body 18a includes an outer member 35 and an inner member 36.

The outer member 35 has a cup shape. The outer member 35 includes the outer diameter side cylindrical portion 19a, and an outer bottom portion 37a having a disc-shape, which closes an end portion opening on the one side in the axial direction of the outer diameter side cylindrical portion 19a.

The inner member 36 includes the inner diameter side cylindrical portion 20a, an inner bottom portion 37b having a disc-shape, which closes an end portion opening on the one side in the axial direction of the inner diameter side cylindrical portion 20a, and the plurality of columnar ribs 17a.

The piston body 18a in the present embodiment is implemented by fitting the inner member 36 into the outer member 35 by press-fitting. Specifically, the piston body 18a is implemented by press-fitting an end portion on the one side in the axial direction of the inner diameter side cylindrical portion 20a forming the inner member 36 into an end portion on the one side in the axial direction of the outer diameter side cylindrical portion 19a forming the outer member 35 and by overlapping a side surface on the one side in the axial direction of the inner bottom portion 37b forming the inner member 36 with no gap on a side surface on the other side in the axial direction of the outer bottom portion 37a forming the outer member 35. Therefore, the bottom portion 16a includes the outer bottom portion 37a and the inner bottom portion 37b, and the annular gap 21 is formed between an inner peripheral surface of the outer diameter side cylindrical portion 19a and an inner peripheral surface of the inner diameter side cylindrical portion 20a when the inner member 36 is fitted into the outer member 35.

In the present embodiment, a thickness t of the columnar rib 17a in the radial direction is substantially constant over an entire length. The thickness of the columnar rib 17a in the radial direction is larger than radial thicknesses of the outer diameter side cylindrical portion 19a and the inner diameter side cylindrical portion 20a.

In the present embodiment, the piston body 18a is not one component, but includes two components, the outer member 35 and the inner member 36. Therefore, the piston body 18a can be manufactured by separately manufacturing the outer member 35 and the inner member 36 and then combining the outer member 35 and the inner member 36, which improves the flexibility of the manufacturing method. Specifically, the outer member 35 and the inner member 36 can be manufactured by machining, injection molding, or the like. Therefore, a manufacturing time can be shortened, and a manufacturing cost can be reduced.

Other configurations, operations, and effects are the same as those of the first embodiment.

As described above, a piston for a disc brake device according to an aspect of the present disclosure is fitted to a cylinder of a caliper forming a disc brake device such as an opposed-piston-type disc brake device or a floating-type disc brake device.

A piston for a disc brake device according to an aspect of the present disclosure includes: a cylindrical wall portion having a bottomed cylindrical shape as a whole and having a substantially cylindrical shape; a bottom portion configured to close an end portion on one side in an axial direction, which is configured to be disposed on a deep side of the cylinder, of the cylindrical wall portion; and a plurality of columnar ribs disposed on a radially inner side of the cylindrical wall portion.

The cylindrical wall portion includes an outer diameter side cylindrical portion including a seal sliding contact portion on an outer peripheral surface, an inner diameter side cylindrical portion that is disposed on a radially inner side of the outer diameter side cylindrical portion and that includes a pad contact portion at an end portion on the other side in the axial direction protruding in the axial direction with respect to an end portion on the other side in the axial direction of the outer diameter side cylindrical portion, and an annular gap formed between an inner peripheral surface of the outer diameter side cylindrical portion and an outer peripheral surface of the inner diameter side cylindrical portion.

The plurality of columnar ribs are disposed to be inclined with respect to a piston central axis, and each have an end portion on one side in a length direction connected to a side surface on the other side in the axial direction of the bottom portion, and an end portion on the other side in the length direction connected to an inner peripheral surface of the inner diameter side cylindrical portion.

In the piston for the disc brake device according an aspect of the present disclosure, each of the plurality of columnar ribs has the end portion on the other side in the length direction connected to an end portion on the other side in the axial direction of the inner peripheral surface of the inner diameter side cylindrical portion.

In the piston for the disc brake device according to an aspect of the present disclosure, the plurality of columnar ribs are disposed radially around the piston central axis.

In the piston for the disc brake device according to an aspect of the present disclosure, each of the plurality of columnar ribs has the end portion on the one side in the length direction connected to an intermediate portion in the radial direction of the side surface on the other side in the axial direction of the bottom portion.

In the piston for the disc brake device according to an aspect of the present disclosure, the plurality of columnar ribs are disposed at equal intervals in a circumferential direction.

In the piston for the disc brake device according to an aspect of the present disclosure, the outer diameter side cylindrical portion, the inner diameter side cylindrical portion, and the plurality of columnar ribs are integrally formed.

In the piston for the disc brake device according to an aspect of the present disclosure, the outer diameter side cylindrical portion and the inner diameter side cylindrical portion are formed separately, and the inner diameter side cylindrical portion and the plurality of columnar ribs are integrally formed.

In the piston for the disc brake device according to an aspect of the present disclosure, the inner diameter side cylindrical portion has a communication hole penetrating in the radial direction.

In the piston for the disc brake device according to an aspect of the present disclosure, the communication hole is formed in a portion, in which a phase in the circumferential direction coincides with that of the columnar rib, of the inner diameter side cylindrical portion.

In the piston for the disc brake device according to an aspect of the present disclosure, the communication hole is formed in a vicinity of a connection portion, to which the end portion on the other side in the length direction of the columnar rib is connected, of the inner diameter side cylindrical portion.

In the piston for the disc brake device according to an aspect of the present disclosure, the communication hole is formed in a portion adjacent to one side in the axial direction of the connection portion.

In the piston for the disc brake device according to an aspect of the present disclosure, at least a portion of the communication hole is located on the other side in the axial direction with respect to the end portion on the other side in the axial direction of the outer diameter side cylindrical portion.

In the piston for the disc brake device according to an aspect of the present disclosure, a central axis of the communication hole is inclined with respect to the piston central axis in a direction approaching the one side in the axial direction when extending toward the radially inner side.

In the piston for the disc brake device according to an aspect of the present disclosure, a heat shielding plate is provided on a radially inner side of the inner diameter side cylindrical portion, and the heat shielding plate covers the side surface on the other side in the axial direction of the bottom portion in a state of being in contact with the plurality of columnar ribs.

In the piston for the disc brake device according to an aspect of the present disclosure, the heat shielding plate is configured to be engaged with the plurality of columnar ribs.

In the piston for the disc brake device according to an aspect of the present disclosure, each of the plurality of columnar ribs has an engagement protrusion on a portion in the length direction thereof, the heat shielding plate has engagement holes, and the engagement protrusions are configured to be engaged with the respective engagement holes.

A disc brake device according to an aspect of the present disclosure includes: a caliper having a cylinder; and a piston fitted into the cylinder.

In the disk brake device according to an aspect of the present disclosure, the piston is the piston for the disc brake device according to an aspect of the present disclosure.

According to the piston for a disc brake device according to an aspect of the present disclosure, it is possible to prevent a temperature rise of a brake oil, to make it difficult for heat to be transmitted to a piston seal, to reduce weight, and to ensure the rigidity.

What is claimed is:

1. A piston for a disc brake device, which is configured to be fitted into a cylinder of a caliper forming the disc brake device, the piston for the disc brake device comprising:
a cylindrical wall portion having a bottomed cylindrical shape as a whole and having a substantially cylindrical shape;
a bottom portion configured to close an end portion on one side in an axial direction, which is configured to be disposed on a deep side of the cylinder, of the cylindrical wall portion; and
a plurality of columnar ribs disposed on a radially inner side of the cylindrical wall portion, wherein
the cylindrical wall portion includes an outer diameter side cylindrical portion including a seal sliding contact portion on an outer peripheral surface, an inner diameter side cylindrical portion that is disposed on a radially inner side of the outer diameter side cylindrical portion and that includes a pad contact portion at an end portion on the other side in the axial direction protruding in the axial direction with respect to an end portion on the other side in the axial direction of the outer diameter side cylindrical portion, and an annular gap formed between an inner peripheral surface of the outer diameter side cylindrical portion and an outer peripheral surface of the inner diameter side cylindrical portion, and
the plurality of columnar ribs are disposed to be inclined with respect to a piston central axis, and each have an end portion on one side in a length direction connected to a side surface on the other side in the axial direction of the bottom portion, and an end portion on the other side in the length direction connected to an inner peripheral surface of the inner diameter side cylindrical portion.

2. The piston for the disc brake device according to claim 1, wherein
each of the plurality of columnar ribs has the end portion on the other side in the length direction connected to an end portion on the other side in the axial direction of the inner peripheral surface of the inner diameter side cylindrical portion.

3. The piston for the disc brake device according to claim 1, wherein
the plurality of columnar ribs are disposed radially around the piston central axis.

4. The piston for the disc brake device according to claim 1, wherein
each of the plurality of columnar ribs has the end portion on the one side in the length direction connected to an intermediate portion in the radial direction of the side surface on the other side in the axial direction of the bottom portion.

5. The piston for the disc brake device according to claim 1, wherein
the plurality of columnar ribs are disposed at equal intervals in a circumferential direction.

6. The piston for the disc brake device according to claim 1, wherein
the outer diameter side cylindrical portion, the inner diameter side cylindrical portion, and the plurality of columnar ribs are integrally formed.

7. The piston for the disc brake device according to claim 1, wherein
the outer diameter side cylindrical portion and the inner diameter side cylindrical portion are formed separately, and the inner diameter side cylindrical portion and the plurality of columnar ribs are integrally formed.

8. The piston for the disc brake device according to claim 1, wherein
the inner diameter side cylindrical portion has a communication hole penetrating in the radial direction.

9. The piston for the disc brake device according to claim 8, wherein
the communication hole is formed in a portion, in which a phase in the circumferential direction coincides with that of the columnar rib, of the inner diameter side cylindrical portion.

10. The piston for the disc brake device according to claim 8, wherein
the communication hole is formed in a vicinity of a connection portion, to which the end portion on the other side in the length direction of the columnar rib is connected, of the inner diameter side cylindrical portion.

11. The piston for the disc brake device according to claim 10, wherein
the communication hole is formed in a portion adjacent to one side in the axial direction of the connection portion.

12. The piston for the disc brake device according to claim 8, wherein
at least a portion of the communication hole is located on the other side in the axial direction with respect to the end portion on the other side in the axial direction of the outer diameter side cylindrical portion.

13. The piston for the disc brake device according to claim 8, wherein
a central axis of the communication hole is inclined with respect to the piston central axis in a direction approaching the one side in the axial direction when extending toward the radially inner side.

14. The piston for the disc brake device according to claim 1, wherein
a heat shielding plate is provided on a radially inner side of the inner diameter side cylindrical portion, and
the heat shielding plate covers the side surface on the other side in the axial direction of the bottom portion in a state of being in contact with the plurality of columnar ribs.

15. The piston for the disc brake device according to claim 14, wherein
the heat shielding plate is configured to be engaged with the plurality of columnar ribs.

16. The piston for the disc brake device according to claim 15, wherein
each of the plurality of columnar ribs has an engagement protrusion on a portion in the length direction thereof,
the heat shielding plate has engagement holes, and
the engagement protrusions are configured to be engaged with the respective engagement holes.

17. A disc brake device comprising:
a caliper having a cylinder; and
a piston fitted into the cylinder, wherein
the piston is the piston for the disc brake device according to claim 1.
